(19) United States
(12) Patent Application Publication
(10) Pub. No.: US 2005/0256764 A1
(43) Pub. Date: Nov. 17, 2005

(54) Method and system for generating sales opportunities

(76) Inventors: Marc D. Beaumont, HOMEWOOD, AL (AL); Carlton G. Rhodes, Birmingham, AL (US)

Correspondence Address: Kenneth M Bush;Bush Intellectual Property Law Group, PO Box 381146, Birmingham, AL, 35238, US

(21) Appl. No.: 10/505,618

(22) PCT Filed: May 11, 2004
(86) PCT No.: PCT/US04/14716

§ 371 Date: Aug. 20, 2004

(51) Int. Cl. G06F 17/60

(52) U.S. Cl. 705/14

(57) ABSTRACT

A method for generating sales opportunities by identifying and qualifying recipients to receive one or more electronic messages that contain content that has been optimized based on the profile of the recipients. The message is optimized to ensure compliance with established standards and statutes, and to increase the probability of an affirmative response. Responses from recipients are analyzed and reported, and the analysis of the responses can further identify and qualify the recipient and predict the responses of potential recipients with similar profiles. The process of identifying, qualifying, and profiling recipients for the purpose of prospecting for sales and referrals is continually repeated without limitation to increase the probability, rate, and magnitude of sales opportunities.

### TECHNICAL FIELD

The present invention relates to marketing methods and systems and, more particularly, to a method and system for generating sales opportunities through electronic communication to qualified recipients for the purpose of prospecting these recipients and seeking referrals from recipients. The method is designed to ensure compliance with established standards and statutes, and to increase the probability of an affirmative response.

### BACKGROUND ART

In order to generate sales it is first necessary to present a product, service, or opportunity to a potential buyer. A traditional form of generating retail sales involves the creation of a store, advertising the products or services, displaying the products in the store, and making contact with a prospective customer in the store. The store can be a physical building or an electronic website.

Other methods of generating sales include direct marketing and network marketing. However, making a successful first contact with potential customers is more difficult because there is no established location that a potential customer can visit to educate themselves on the features or benefits of the products or services being offered for sale. This is made even more difficult in situations where the selling of the products and services is regulated by state and/or federal agencies. Nevertheless, once successful contact is made in a direct or network marketing system, the probability of completing a sale is relatively high. Thus, increasing the probability and rate of successful contacting will increase sales volume.

One way to achieve efficiency is to automate the process of making initial contacts and concluding transactions. Automatic mass mailings to people using mailing lists produce very small percentages of successful first contacts, usually less than three percent. These types of mailings, whether hard copy or electronic, are often referred to as junk mail or spam. A similar approach can be performed with automated telemarketing, which also has a relatively low success rate. The low success rate with these existing methods is based, in part, upon the inability to qualify the contact or recipient, to tailor a message for a specific contact or recipient based upon a qualification of the recipient, and the ability to communicate with a “warm” contact as opposed to a “cold” contact. What is needed, therefore, is a cost-effective method and system that will automatically qualify recipients, facilitate communications with “warm” contacts electronically on both an individual level and large scale, process responses from the recipients, and offer an educative, one-to-one, branded environment via these communications similar to that of a physical storefront or a product/services website, all while operating within state and federal regulatory guidelines.

### DISCLOSURE OF INVENTION

The present invention is a method and system for generating sales opportunities by electronically contacting a recipient/prospect for the purpose of securing a sale or referrals from the recipient. A library of various electronic messages is created based upon the perceived needs, desires, characteristics, and demographics of the message recipients. Recipients are identified by users of the method and system of the present invention based upon prior contacts or relationships with the recipients, thereby establishing “warm” contacts or qualified recipients. An electronic message, such as an email message, is selected from the library based upon a profile of the recipient. The message is automatically approved for process, corporate, regulatory, and third-party compliance. The message is automatically sent to each recipient from a list of selected recipients, enabling the recipients to respond to the message. The response from a recipient is analyzed regarding information supplied by the recipient and as to whether the response is positive or negative. If the response is positive, a meeting is scheduled with the recipient and/or a product or service is provided for sale. Information provided by the recipient's response is used to further qualify the recipient and expand the recipient's profile.

An advantage of the present invention is the ability to select an electronic message for a recipient from a message library based upon the identification, qualification, and profile of the recipient.

Another advantage is the ability to automatically optimize the message content to correspond to the perceived needs, desires, characteristics, and demographics of the message recipients in order to increase the probability of an affirmative response.

Another advantage is the ability to automatically adhere to process, corporate, regulatory and third-party compliance requirements.

Another advantage is the ability to automatically analyze a recipient's response in order to schedule a meeting, provide products or services for sale, and to update the recipient's profile.

Another advantage is the ability to prospect customers and potential customers for sales and referrals.

Another advantage is the ability to contact large numbers of “warm market” recipients automatically and electronically using the Internet, thereby increasing the rate of effective communications and magnitude of sales opportunities.

### BRIEF DESCRIPTION OF THE DRAWINGS

FIG. 1 illustrates the method of the present invention for electronically contacting established and prospective customers and arranging a meeting or offering a product for sale.

FIG. 2 shows the compliance-specific approval steps required in preparing a message for electronic transmission.

FIG. 3 illustrates the relationship between initial contacts or recipients, obtaining referrals from initial recipients, and prospecting recipients to promote products and solicit sales.

FIG. 4 illustrates the system of the present invention.

FIG. 5 shows the process by which user-composed message text is screened for the appearance of non-compliant words or phrases.

FIG. 6 illustrates the steps that a message recipient takes to request that restrictions be placed on the delivery of future email messages.

FIG. 7 shows the steps that a contact and user take to modify restrictions that the contact had previously placed on the delivery of email messages.

FIG. 8 shows the steps that a contact and a friend, who is acting on behalf of a user, take to modify restrictions that the contact had previously placed on the delivery of email messages.

### BEST MODE FOR CARRYING OUT THE INVENTION

While the following description details the preferred embodiments of the present invention, it is to be understood that the invention is not limited in its application to the details of construction and arrangement of the parts or steps since the invention is capable of other embodiments and of being practiced in various ways.

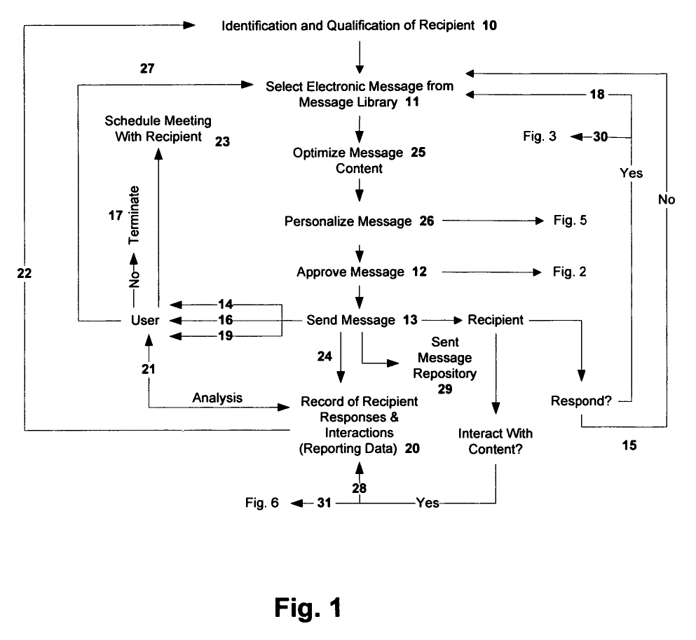

FIG. 1 shows a diagram of the method of the present invention for generating sales opportunities by creating electronic messages, such as email, to send to qualified recipients. Users of this method are sales persons, brokers, agents, trainees, and the like that generate sales opportunities by contacting established and prospective customers (recipients or contacts) directly. In step 10 a user identifies one or more recipients that have some relationship to the user, such as, for example, a friend, an acquaintance, a relative, or some other association. A variety of electronic messages are created to form an online library from which a user can select a specific message for a given product (step 11). The more information that is known about a recipient (recipient profile) and the closer the relationship (the “warmer” the contact) of the user to the recipient, the greater the qualification of the recipient. The more qualified the recipient, the more appropriate and accurate is the selection of the message from the library (step 11).

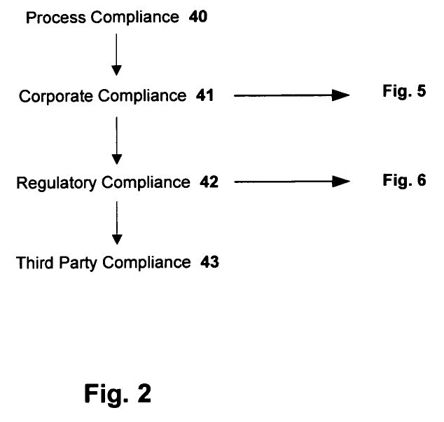

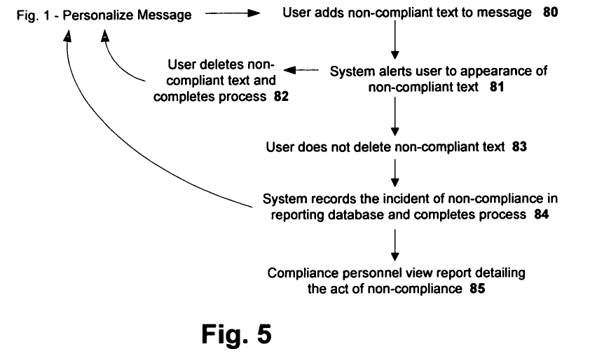

After a message is selected, it is further optimized by applying the appropriate graphics, wording, text formatting, web links, and document style (step 25). The message can be automatically personalized by adding the recipient's and sender's contact information to the message content (step 26) or the user may choose to manually add text to the message, as detailed in FIG. 5. Once assembled, the message is approved based upon one or more compliance criteria (step 12). The approval process is illustrated in greater detail in FIG. 2. After the approval process, the message may be sent to the recipient (step 13) with a copy going to the user (step 14) and to a message repository to be archived for possible later retrieval and viewing and/or to be audited for the appearance of non-compliant content (step 29). Messages can be sent to an unlimited number of recipients from a previously constructed contact list, and the user and/or system can be required to complete a given number of predefined events or steps before the message is sent (step 12). The message can be constructed to enable a recipient to interact with the message and respond as desired, for example, by clicking on one or more links that lead to external web pages (step 28), opting to discontinue the receipt of future emails (step 31), or by responding to the message via actionable “affirmative response” links contained within the message content (step 18) for the purpose of arranging a meeting (step 23) or agreeing to offer referrals (step 30).

The message may be a solicitation for the sale of a product (goods or services), a request for a meeting, an invitation to and event, or serve other business-related purposes. A message will typically will have a greeting, some background information, description of the product, links to external web content, and a request for a response. Typical responses may be “yes, I am interested” (Step 18) or “please send more information.” The message may also request demographic data such as address, phone numbers, date of birth, marital status, number of children, product preferences, and the like. If there is no response (step 15) within specified period of time, a follow up message is automatically sent to the user (step 16) informing the user of the non-response of the recipient and providing a phone script to use to call the recipient and inquire as to the reasons for the lack of response. If there is no response to the follow up contact (step 17), further electronic contacting may be terminated.

If the recipient responds by clicking on an affirmative response link (step 18), a notification message is automatically sent to the user (step 19) and the recipient's response is recorded in the record of recipient responses and interactions (step 24). The analysis of the response is then made available to the user (step 21), and is also used to update the recipient's profile (step 22). The response to the user (step 19) may indicate that the recipient wishes to schedule a meeting, which is then scheduled (step 23) or indicate a desire for additional information, in which case the user will select the appropriate message from the message library and send it to the contact (step 27).

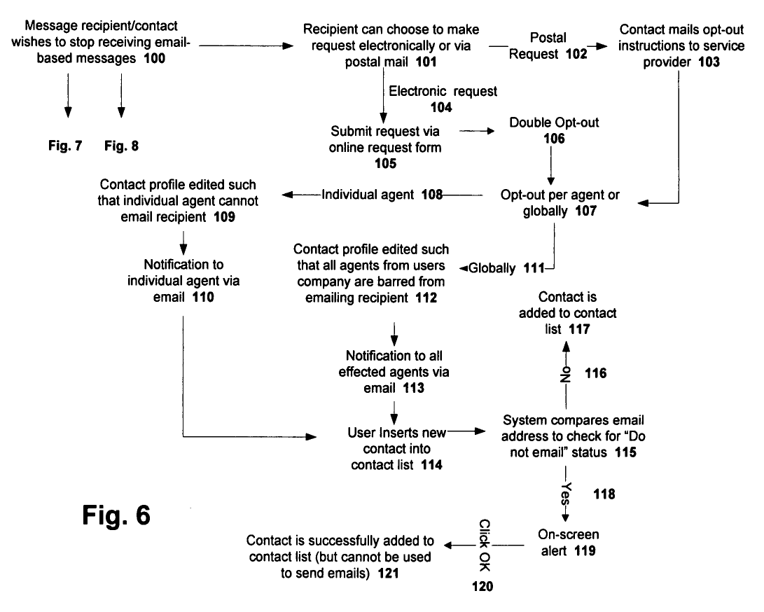

FIG. 2 shows the approval steps in preparing the message before it is sent to the recipient. A user or the system may be required to follow a predefined sequence of steps in order to create and/or send the message (step 40). The message may have to adhere to certain corporate-defined rules (step 41), and may therefore be screened for the appearance of company-defined non-compliant keywords and phrases as detailed in FIG. 5, and the user may be required to qualify the status of contact information or the relationship to the intended recipient. In step 42 the message is screened for regulatory compliance, which may require verifying the licensing or certification status of a user. Additionally, legally required text may be added to the message. A recipient's profile may be modified based upon the analysis of the recipient's interactions with a message as it applies to certain rights provided the recipient under state or federal regulatory policies or laws, as detailed (FIG. 6) Third-party compliance (step 43) entails automatically modifying message content to allow it to pass through third-party message filters.

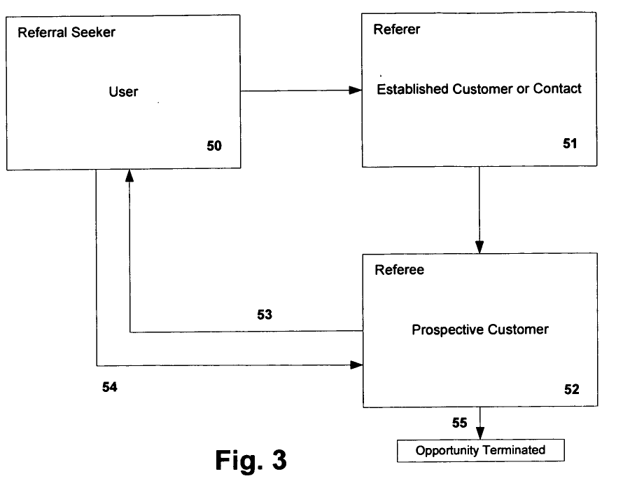

FIG. 3 illustrates the relationship between the user (50), the established customer or contact (51), and the prospective customer (52) with regards to obtaining referrals from the established customer or contact for the purpose of prospecting the prospective customers to promote products and solicit sales. A user (50), for example, creates a list of established customers or contacts (51), each of whom are identified and qualified as described above., The user sends referral request messages to as many established customers or contacts (51) at one time as desired using the method of the present invention. The purpose of the referral request message is to ask established customers and contacts (51) to send referral/solicitation messages to their “warm market” contacts/prospective customers (52) on behalf of the user using the message creation and delivery system of the present invention. The prospective customers may indicate their desire to meet (53) with the user by clicking on an “affirmative response” link, such as “Yes, I would like to meet.” The user may then contact (54) the prospective customer using contact information provided by the established customer/referrer during the message creation and delivery process. Once the prospective customer becomes an established customer or contact, the cycle repeats without limitation to increase the rate and magnitude of sales opportunities. If the prospective customer chooses not to respond in the affirmative, then the opportunity to meet is terminated (55) and the user is denied access to the prospective customer's contact information thereby eliminating the possibility of any future communications via the system of the present invention. As the list of contacts grow, these established customers or contacts (51) and the consenting prospective customers (52) can be contacted by the method of the present invention for continued prospecting. Prospecting is the offer for sale of any goods and/or services by the user, and/or a request for referrals.

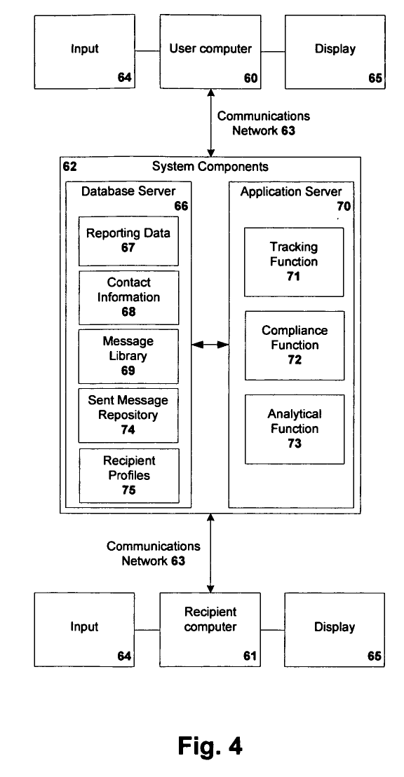

FIG. 4 illustrates the system of the present invention. The user and recipient each have a computer system (60, 61). The user computer (60) can communicate with the recipient computer (61), for example using email, by sending an electronic message over a communication network (63) and through one or more servers, which may include database (66) and application servers (70). Each computer has an input device (64), for example, a key board and mouse, and a display or output device (65), for example a computer screen. The components (62) that comprise the system of the present invention include a database server (66) containing reporting data (67) that includes message recipients' interactions and responses to message content; contact information (68) relating to message recipients such as first name, last name, and email addresses; a message library (69) that contains pre-written messages; a message repository (74) where sent messages are archived; and recipient profiles (75) that are automatically updated/modified based on the ongoing interactions of recipients to message content. The system components (62) also have an application server (70) which can access reporting, messages, and contact information data (66), for preparing messages according to the method of the present invention. The application server (70) has a tracking function (71), a compliance function (72), and an analytical function (73) to implement the method of the present invention.

Any computer systems and software programs known to those skilled in the art may be used within the scope of the invention. Those having ordinary skill will recognize that other computing devices may be utilized. Computers (60, 61) are connected to the communications network (63) using standard methods including telephone lines and broadband communication systems. The system components that comprise the system of the present invention (62) are similarly connected to the communications network (63). Information can be sent from any number of computers to the system components (62). As well, information may be sent from the components (62) to recipients throughout the world via the communications network (63). The communication network (63) used within the scope of the invention may be a Local Area Network (“LAN”) of any type, a Wide Area Network (“WAN”), a private network, a public network including the Internet and the Web, or a telephone network. Communications may be accomplished using standard devices or wireless devices such as telephones, cellular phones, palm pilots, satellite dishes, fax machines, the World Wide Web, cable, or other electronic communication devices or mediums known to those skilled in the art.

It is to be understood that other computer systems and software known to those skilled in the art may also be used. Software or programs within servers or databases elsewhere may be used to carry out the functions and operations described.

FIG. 5 shows the process by which user-composed message text is screened for the appearance of non-compliant words or phrases. A user may add supplemental text to a message selected from the message library (step 80). If the added text includes words or phrases that the user's company has identified as being non-compliant, the system alerts the user as to appearance of the non-compliant text (step 81) and may, in some cases, require the user to remove the non-compliant text prior to progressing to the next step in the process. If the user removes the non-compliant text (step 82), the system continues on to the next step in the process.

If the system is configured to allow the identified non-compliant text to remain in the message, the system alerts the user (step 81) as to the appearance of non-compliant text and provides the user with the option of removing the text. If the user decides to leave the non-compliant text within the message, (step 83) the system records the incident and stores the information in the reporting database (step 84). This information can then be viewed by compliance personnel at the user's company via a compliance monitoring tool provided by the system provider (step 85).

FIG. 6 illustrates the steps that a message recipient takes to request that restrictions be placed on the delivery of future email messages. If the message recipient/contact wishes to stop receiving email-based messages (step 100) the recipient can choose to make the request electronically or via postal mail (step 101). To make an electronic request (step 104) the contact submits the request via an online request form (step 105) which leads to another online form that requires the contact to confirm the request or “double opt-out,” prior to completing the electronic request process (step 106). To make a postal request (step 102) the contact mails opt-out instructions to the system provider (step 103). In the course of submitting an electronic or postal request, the contact can elect to not receive future email messages from the message sender only or more globally from any user that represents the company with which the message sender was associated with at the time of message delivery (step 107). If the recipient chooses not to receive messages from the user/sender only, (step 108) the recipient's profile is edited such that the individual user cannot email the recipient (step 109) using the system of the present invention. The system automatically sends a notification to the individual user via email (step 110). If the recipient chooses not to receive messages on a global basis (step 111) the recipient's profile is edited such that all users from the user's company are barred from emailing the recipient (step 112). The system then sends notification to all effected users via email (step 113). If a user inserts new contact information into the system's contact list (step 114) the system compares the email address to check for “Do Not E-Mail” status (step 115) If the status is negative (step 116) the contact is added to contact list (step 117). If the status is positive (is found to be on the “Do Not E-Mail” list, (step 118) an on-screen alert appears (step 119) and the user is required to acknowledge the status of the contact by clicking “OK” (step 120) prior to the system adding the contact to the contact list. Even after the contact is added to the list, the system will not allow the user to use the email address to send an email to the intended recipient (step 121).

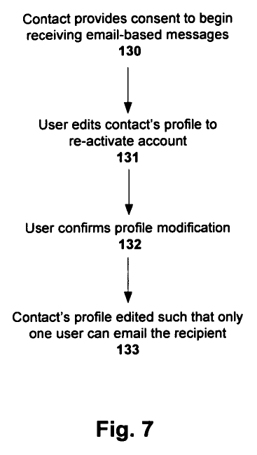

FIG. 7 shows the steps that a contact and user take to modify restrictions that the contact had previously placed on the delivery of email messages. A contact provides consent to an individual user to begin receiving email-based messages, even though the user represents a company that the contact had previously chosen not to receive email-based messages from on a global basis (step 130). The user edits the contact's profile to re-activate email sending capabilities for only that user's account (step 131). Before the system re-activates sending capabilities, the user is required to acknowledge and confirm the profile modification request. If the user provides confirmation (step 132) then the contact's profile is edited such that only that specific user can email the recipient (step 133) until the recipient decides to further modify the restrictions placed on that account.

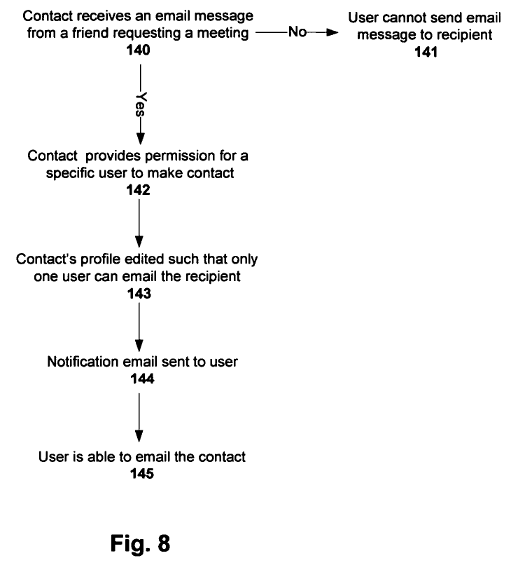

FIG. 8 shows the steps that a contact and a friend, who is acting on behalf of a user, take to modify restrictions that the contact had previously placed on the delivery of email messages. A contact receives an email message from a friend requesting a meeting on behalf of a user associated with a company that the contact had previously notified to stop all users from that company from sending the contact email-based messages (step 140). If the contact chooses not to respond to the request the user cannot contact message recipient because permission was not granted (step 141). If the message recipient chooses to provide permission for the specific user to make contact, the recipient does so by responding to an offer within the message (step 142). In so doing, the contact's profile is edited such that only the user specified in the message can email the contact (step 143) and a notification email is sent to user indicating that the contact accepts the request for a meeting (step 144). The user referred by the friend can now use the system of the present invention to email the recipient (step 145) until the recipient decides to further modify the restrictions placed on that account.

### EXAMPLE

A user, Tom, uses his computer (60, 64, 65) and Internet service provider (63) to access the system (62) using a pre-assigned user name and password for the purpose of sending a system-generated email to a recipient, for example, his wife's brother, Bill (10). The purpose of the message is to schedule a face-to-face meeting to discuss Bill's potential need for life insurance. Because Tom indicated during the online registration process, which is required to gain access to the system of the present invention, that he is a licensed insurance agent (41), he is able to view and select “Insurance” from a menu of products and services offered by his company (11).

Prior to selecting a specific life insurance product or message, Tom is required to enter Bill's contact information, such as first name, last name, email address, and phone number, (68) into designated fields (64). He can also enter additional information, such as Bill's age, number of children and their ages, marital status, occupation, and the like, which can be used by the system to refine Bill's profile (75).

At this time, the system also verifies that Bill's email address is not tagged “Do Not Email” on the company's global “Do Not Email” list (115) and that the phone number 25 is not on any federal, state, or corporate-sponsored “Do Not Call” lists (42). Had the email address been tagged, Tom would have been allowed to add the email address to his contact list but would not be able to select the address for the purpose of sending a message (121). Similarly, if the phone number was identified as being on a “Do Not Call List,” it would be red-lined and identified as a non-compliant number. Since both the email address and phone number are not on any list, Tom is next required to check a box indicating that he has read and agrees with one or more compliance-oriented statements verifying the relationship between user and recipient (41). Once the box is checked, Tom is able to select “Term Insurance” from the product selection page and then a message from the message library (11), which contains pre-written, corporate-approved messages for all of the Term Insurance products offered by Tom's company (41). Since Bill isn't yet a client of Tom's, he selects a message that matches the recipient's profile (75), which in this case is “Term Insurance—Prospect” (11).

Prior to viewing the message, Tom checks a box that instructs the system to merge Bill's contact information into the message text to create a more personalized message (26). He also elects to add his own personal greeting to the beginning of the pre-written message (FIG. 5). In the course of writing his opening sentence, Tom uses the word “free,” which is one of several words that the compliance department at Tom's company has instructed the system to monitor within user correspondences (41, 80). As a result of Tom having used the word “free” in his message, an alert appears on Tom's computer screen when he attempts to send the message (81), indicating that he has used the word “free” and that it has been designated by corporate as a non-compliant word. Tom chooses to rewrite the sentence, removing the word “free” (82). Had Tom left the word “free” in the message, (83) the system would have recorded the incident (72, 84) and stored that information in the reporting database, (67) and displayed the occurrence of non-compliance in text/numeric fashion on the main administrative screen (65) of a compliance monitoring tool as a means of notifying compliance personnel to the act of non-compliance (85). Compliance personnel at Tom's company can add, edit, or delete “trackable” non-compliant words and phrases at will and can monitor their appearance in agent correspondence in real-time.

Tom then clicks the “Preview” button (40) to view the message before sending it to Bill. Before the message appears, the system optimizes the message content (25) by customizing supplemental URLs (embedded web links) that accompany the message, based on Bill's profile (75) and the interactions of past recipients (20) who share a similar profile. Tom previews the message to make sure everything is to his liking, and then clicks “Send,” which initiates the delivery process. Before the message is actually sent, however, the system reviews the message content to verify that it conforms to all compliance criteria (FIG. 2) which includes the message's ability to pass through third party message filters (43). If it will not pass through the filters, based on pre-defined criteria, the content's code is automatically modified to allow it to pass through the filters (43) without visibly altering the viewable content.

The system sends the email to Bill (13). A copy of the message is sent to Tom's inbox (14) and another copy is stored in the system's message repository for archiving purposes (29). Bill uses his computer's email package and Internet connection (61, 63, 65) to open and view the email from Tom. Bill interacts with the email by clicking on web links titled “Debt Consolidation” and “Long Term Care” (64, 28). By doing so, Bill is able to view product-specific web pages that reside on Tom's company's web site. However, Bill did not click on the “Yes, I would like to meet” button within the message within 48 hours of receiving the message (15), so Tom receives an automated follow up notification (16) in his email box. The notification includes Bill's full name and phone number, along with a phone script that serves as a guide for what Tom should say when calling Bill to determine why he hasn't yet responded. Tom calls Bill and asks, “Did you receive my email? Do I need to resend it?” Bill verbally acknowledges that he has received the message and agrees to closely examine the email later that day. Bill later clicks “Yes” to indicate he wants to meet with Tom (18).

All of Bill's interactions with the message (71), including opening the email, clicking on the web links, and clicking on the “Yes” button are all recorded in the system's database (67) for the purpose of future analysis (73), which is accessible to Tom and select administrators at Tom's company (20). Tom receives notification via email that Bill clicked “Yes” and wants to meet to discuss life insurance (19). The message also provides Bill with a way to sign up for the “Do Not Email” list pertaining to a single employee (Tom) or to all employees within Tom's company (42, FIG. 6).

Tom knows from viewing the analysis of Bill's recorded message interactions (21) that Bill is interested in life insurance and debt consolidation (20). Bill's profile is updated (22) to record that a 45 year old white male with two teenage children expressed an interest in life insurance and debt consolidation (75). These demographic and psychographic details were known to Tom due to the “warm” nature of their relationship and were entered into the system by Tom during the contact creation process. Over time, if recipients with similar profiles express the same or similar interaction behavior to life insurance messages, then the system will automatically re-optimize the message content (25) sent to individuals with similar profiles by always including one or more links for debt consolidation. Tom calls Bill and schedules a meeting (23). Tom and Bill meet for coffee to discuss Bill's financial needs, which includes a review of debt consolidation options. At their follow up meeting, Bill decides to purchase life insurance from Tom, and also submits an application to refinance his mortgage for the purpose of consolidating some short-term debt.

At the conclusion of the sale, Tom (50) informs Bill that he is going to send him an email message that asks Bill to consider referring his friends, family, or business associates to Tom. Bill agrees to look for the email and begins thinking of possible referral names for Tom. Bill receives the system-generated referral message (51) the next day. He reads the message and then clicks on the button that reads, “Yes, I will send some referral messages,” (30) at which point an Internet browser window pops up and displays an online form that Bill fills in (61, 65, 64, 63, 62) with the first names, last names, phone numbers, and email addresses for five friends who he thinks would benefit from meeting with Tom and learning about the financial services he offers. Bill then clicks the “Preview” button and is able to read the pre-written message that he will send to his friends. He notices that each friend's name, and both his and Tom's name and contact information has been automatically merged into the messages, making for a very personalized note (26). Bill then clicks on the “Send” button, thereby delivering the five personalized messages to his five friends (13). Of the five friends who receive the email, three respond immediately (53) by clicking an affirmative response link titled, “Yes, I would like to learn more.” By doing so, each referee sees a pop-up window appear with text thanking him or her for responding and indicating that Tom will contact him or her to arrange an appointment. At the same time, three automated email messages are sent to Tom notifying him of each referee's desire to meet. Each message contains the referee's contact information, including phone number, which was provided by Bill when he filled in the online form. Tom contacts each of the contacts provided by Bill to arrange a meeting (54).

Tom meets with all three individuals referred by Bill. Two purchase financial services from Tom and one of the three, who is named Steve, indicates a desire to join Tom's company as an independent sales agent working under Tom's guidance. Steve fills out the necessary paperwork and is now ready to let his “warm market” of friends and family know about his new part-time job. To expedite the communication process, the system provides Steve with a phone script that he uses to contact ten friends to let each of them know that he is sending an email with information about a new business opportunity he is pursuing. Once the calls are completed, Tom lends Steve the use of his Provider account to contact his ten warm market contacts using the Provider service. Tom goes online, accesses his account, and with Steve sitting next to him, enters the contact information for ten of Steve's closest friends (60, 64, 65, 63, 62).

Tom then clicks the “Preview” button to allow Steve to read the pre-written message (30) that he is sending to his ten friends. Tom then clicks on the “Send” button, thereby delivering the ten personalized (13) messages. Of the ten friends who receive the email, six respond immediately by clicking the button titled, “Yes, I would like to learn more” (18). By doing so, each responding recipient sees a pop-up window appear with text thanking him or her for responding and indicating that Tom and Steve will contact him or her to arrange an appointment. At the same time, six automated email messages are sent to Tom (19) notifying him of each respondent's desire to meet. Each message contains the respondent's contact information, including phone number, which was provided by Steve when he filled in the online form. Forty-eight hours after having sent the ten messages, Steve receives an email (16) listing the contact information for each friend who has not yet responded and a phone script to use in following up with each non-respondent. This method of the present invention is, thus, continuously implemented to continually generate sales opportunities.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention.

It will be understood that various changes in the details, materials, and arrangements of the parts which have been described and illustrated above in order to explain the nature of this invention may be made by those skilled in the art without departing from the principle and scope of the invention as recited in the following claims.

1. A method for generating sales opportunities, comprising the steps of:
1) creating a library of electronic messages;
2) identifying and qualifying recipients to receive said messages;
3) selecting and approving one or more messages selected from said library for one or more recipients based upon profiles of said recipients; and
4) sending said message to said recipient and enabling said recipient to respond to said message.

2. The method of claim 1 further comprising the step of analyzing a response from said recipient.

3. The method of claim 1 further comprising the step of offering in said message products or services for sale, or requesting a referral, or requesting a meeting, or a combination thereof.

4. The method of claim 1 further comprising the step of prospecting customers or potential customers for referrals or for sales or for both.

5. The method of claim 1 wherein the step of approving comprises process compliance, corporate compliance, regulatory compliance, or third party compliance; or a combination thereof.

6. The method of claim 1 wherein the step of sending said message is through the Internet and a response from said recipient is sent through the Internet.

7. The method of claim 1 wherein the step of selecting said message further comprises optimizing said message based upon identification of said recipient and said recipient's profile.

8. The method of claim 2 wherein the analysis of said response is used to further identify and qualify said recipient.

9. The method of claim 6 wherein the step of sending said message comprises sending a plurality of messages from a contact list based upon the occurrence of predefined events.

10. A method for generating sales opportunities, comprising the steps of:
1) creating a library of electronic messages;
2) identifying and qualifying recipients to receive said messages;
3) selecting and approving one or more messages selected from said library for one or more recipients based upon profiles of said recipients;
4) sending said message to said recipient and enabling said recipient to respond to said message;
5) analyzing a response from said recipient; and
6) prospecting customers or potential customers for referrals or for sales or for both.

11. The method of claim 10 further comprising the step of offering in said message products or services for sale, or requesting a referral, or requesting a meeting, or a combination thereof.

12. The method of claim 10 wherein the step of approving comprises process compliance, corporate compliance, regulatory compliance, or third party compliance; or a combination thereof.

13. The method of claim 10 wherein the step of sending said message is through the Internet and a response from said recipient is sent through the Internet.

14. The method of claim 10 wherein the step of selecting said message further comprises optimizing said message based upon identification of said recipient and said recipient's profile.

15. The method of claim 10 wherein the analysis of said response is used to further identify and qualify said recipient.

16. The method of claim 13 wherein the step of sending said message comprises sending a plurality of messages from a contact list based upon the occurrence of predefined events.

17. A method for generating sales opportunities, comprising the steps of:
1) creating a library of electronic messages;
2) identifying and qualifying recipients to receive said messages;
3) selecting and approving one or more messages selected from said library for one or more recipients based upon profiles of said recipients;
4) sending said message to said recipient and enabling said recipient to respond to said message;
5) analyzing a response from said recipient;
6) offering in said message products or services for sale, or requesting a referral, or requesting a meeting, or a combination thereof; and
7) prospecting customers or potential customers for referrals or for sales or for both.

18. The method of claim 17 wherein the step of approving comprises process compliance, corporate compliance, regulatory compliance, or third party compliance; or a combination thereof.

19. The method of claim 18 wherein the step of sending said message is through the Internet and a response from said recipient is sent through the Internet.

20. The method of claim 19 wherein the step of selecting said message further comprises optimizing said message based upon identification of said recipient and said recipient's profile.

21. The method of claim 20 wherein the analysis of said response is used to further identify and qualify said recipient.

22. The method of claim 21 wherein the step of sending said message comprises sending a plurality of messages from a contact list based upon the occurrence of predefined events.

23. The method of claim 5 wherein corporate compliance includes screening user-composed message text for the appearance of non-compliant words and phrases, and regulatory compliance includes enabling a recipient of a message to request that restrictions be placed on the delivery of future messages.

24. The method of claim 12 wherein corporate compliance includes screening user-composed message text for the appearance of non-compliant words and phrases, and regulatory compliance includes enabling a recipient of a message to request that restrictions be placed on the delivery of future messages.

25. The method of claim 18 wherein corporate compliance includes screening user-composed message text for the appearance of non-compliant words and phrases, and regulatory compliance includes enabling a recipient of a message to request that restrictions be placed on the delivery of future messages.
